(19) United States
(12) Patent Application Publication
(10) Pub. No.: US 2022/0272754 A1
(43) Pub. Date: Aug. 25, 2022

(54) Method and Apparatus for Sharing Channel Occupancy Time

(71) Applicant: Lenovo (Beijing) Limited, Beijing (CN)

(72) Inventor: Haipeng Lei, Haidian District (CN)

(73) Assignee: Lenovo (Beijing) Limited, Beijing (CN)

(21) Appl. No.: 17/630,076

(22) PCT Filed: Aug. 9, 2019
(86) PCT No.: PCT/CN2019/100033

§ 371 Date: Jan. 25, 2022

(51) Int. Cl. H04W 74/08; H04W 74/00; H04W 72/04

(52) U.S. Cl. CPC H04W 74/0816; H04W 74/0866; H04W 74/004; H04W 72/0446

(57) ABSTRACT

The present application relates to a method and apparatus for sharing channel occupancy time. One embodiment of the subject application provides a method performed by a user equipment (UE) for wireless communication, comprising: receiving, from a base station (BS), a signaling configuring resource for transmitting uplink data; performing a channel access procedure for transmitting the uplink data on the configured resource and obtaining a channel occupancy time (COT); transmitting, to the BS, the uplink data on the configured resource within the COT; and transmitting, to the BS, uplink control information (UCI) associated with the uplink data indicating subsequent time resource within the COT is available for the BS for downlink transmission.

### TECHNICAL FIELD

The subject application relates to Generation Partnership Project (3GPP) 5G new radio (NR), especially to a method and apparatus for sharing channel occupancy time (COT).

### BACKGROUND OF THE INVENTION

Base stations (BSs) and user equipment (UE) may operate in both licensed and unlicensed spectrum. In LTE Rel-15 Further enhanced Licensed Assisted Access (FeLAA), Autonomous Uplink (AUL) transmission is supported for unlicensed spectrum. In this way, UE can perform the Physical Uplink Shared Channel (PUSCH) transmission on the configured time-frequency resources without waiting for an uplink (UL) grant from the BS. Also, the BS can avoid transmitting UL grant and performing channel access procedure for transmitting the UL grant.

To improve the utilization of radio resource, a UE-initiated COT for AUL transmission can be shared with a base station for downlink (DL) transmission.

### SUMMARY

It is desirable to provide a solution to a method for sharing the COT in NR network.

One embodiment of the subject application provides a method performed by a user equipment (UE) for wireless communication, comprising: receiving, from a base station (BS), a signaling configuring resource for transmitting uplink data; performing a channel access procedure for transmitting the uplink data on the configured resource and obtaining a channel occupancy time (COT); transmitting, to the BS, the uplink data on the configured resource within the COT; and transmitting, to the BS, uplink control information (UCI) associated with the uplink data indicating subsequent time resource within the COT is available for the BS for downlink transmission.

Another embodiment of the subject application provides a method performed by a base station (BS) for wireless communications, comprising: transmitting, to a user equipment (UE), a signal configuring resource for transmitting uplink data; receiving, from the UE, the uplink data on the configured resource within a channel occupancy time (COT), wherein the COT is initiated by the UE after preforming a channel access procedure; receiving, from the UE, uplink control information (UCI) associated with the uplink data indicating subsequent time resource within the COT is available for the BS for downlink transmission; and transmitting downlink transmission in the subsequent time resource.

Yet another embodiment of the subject application provides an apparatus, comprising: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the method performed by a user equipment (UE) for wireless communication, comprising: receiving, from a base station (BS), a signaling configuring resource for transmitting uplink data; performing a channel access procedure for transmitting the uplink data on the configured resource and obtaining a channel occupancy time (COT); transmitting, to the BS, the uplink data on the configured resource within the COT; and transmitting, to the BS, uplink control information (UCI) associated with the uplink data indicating subsequent time resource within the COT is available for the BS for downlink transmission.

Still another embodiment of the subject application provides an apparatus, comprising: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the method performed by a base station (BS) for wireless communications, comprising: transmitting, to a user equipment (UE), a signal configuring resource for transmitting uplink data; receiving, from the UE, the uplink data on the configured resource within a channel occupancy time (COT), wherein the COT is initiated by the UE after preforming a channel access procedure; receiving, from the UE, uplink control information (UCI) associated with the uplink data indicating subsequent time resource within the COT is available for the BS for downlink transmission; and transmitting downlink transmission in the subsequent time resource.

### BRIEF DESCRIPTION OF THE DRAWINGS

FIG. 1 illustrates a schematic diagram of a wireless communication system in accordance with some embodiments of the present application.

FIG. 2 illustrates a UE-initiated COT in NR network according to one embodiment of the subject application.

FIG. 3 illustrates a structure of the UE-initiated COT in NR network according to one embodiment of the subject application.

FIG. 4 illustrates an allocation of the COT in NR network according to one preferred embodiment of the subject application.

FIG. 5A illustrates a DL time domain resource allocation table for normal cyclic prefix (CP) according to one embodiment of the subject application.

FIG. 5B illustrates another DL time domain resource allocation table for normal CP according to one embodiment of the subject application.

FIG. 6 illustrates an allocation of COT determined by a slot format combination (SFC) according to one embodiment of the subject application.

FIG. 7 illustrates an allocation of COT determined by the SFC according to another embodiment of the subject application.

FIG. 8 illustrates an allocation of COT determined by the SFC according to yet another embodiment of the subject application.

FIG. 9 illustrates a method performed by a UE for wireless communication according to a preferred embodiment of the subject disclosure.

FIG. 10 illustrates a method performed by a BS for wireless communication according to a preferred embodiment of the subject disclosure.

FIG. 11 illustrates a block diagram of a UE according to the embodiments of the present disclosure.

FIG. 12 illustrates a block diagram of a BS according to the embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

Embodiments provide a method and apparatus for downlink (DL) or uplink (UL) data transmission on unlicensed spectrum. To facilitate understanding, embodiments are provided under specific network architecture and new service scenarios, such as 3GPP 5G, 3GPP LTE Release 8 and so on. Persons skilled in the art know very well that, with the development of network architecture and new service scenarios, the embodiments in the present disclosure are also applicable to similar technical problems.

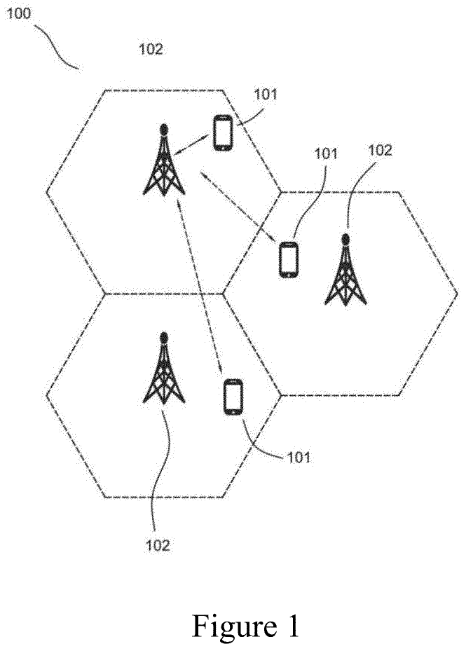

FIG. 1 depicts a wireless communication system 100 according to an embodiment of the present disclosure.

As shown in FIG. 1, the wireless communication system 100 includes UE 101 and BS 102. In particular, the wireless communication system 100 includes three UEs 101 and three BSs 102 for illustrative purpose only. Even though a specific number of UEs 101 and BSs 102 are depicted in FIG. 1, one skilled in the art will recognize that any number of UEs 101 and BSs 102 may be included in the wireless communication system 100.

The UEs 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UEs 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UEs 101 include wearable devices, such as smart watches, fitness bands, optical head-mounted displays, or the like. Moreover, the UEs 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UEs 101 may communicate directly with the BSs 102 via uplink (UL) communication signals.

The BSs 102 may be distributed over a geographic region. In certain embodiments, each of the BSs 102 may also be referred to as an access point, an access terminal, a base, a macro cell, a Node-B, an enhanced Node B (eNB), a gNB, a Home Node-B, a relay node, or a device, or described using other terminology used in the art. The BSs 102 are generally part of a radio access network that may include one or more controllers communicably coupled to one or more corresponding BSs 102.

The wireless communication system 100 is compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3rd Generation Partnership Project (3GPP)-based network, a 3GPP 5G network, a satellite communications network, a high altitude platform network, and/or other communications networks.

In one embodiment, the wireless communication system 100 is compatible with the 5G new radio (NR) of the 3GPP protocol, wherein the BSs 102 transmit data using an orthogonal frequency division multiplexing (OFDM) modulation scheme on the downlink and the UEs 101 transmit data on the uplink using Discrete Fourier Transform-Spread-Orthogonal Frequency Division Multiplexing (DFT-S-OFDM) or Cyclic Prefix-Orthogonal Frequency Division Multiplexing (CP-OFDM) scheme. More generally, however, the wireless communication system 100 may implement some other open or proprietary communication protocols, for example, WiMAX, among other protocols.

In other embodiments, the BSs 102 may communicate using other communication protocols, such as the IEEE 802.11 family of wireless communication protocols. Further, in some embodiments, the BSs 102 may communicate over licensed spectrums, whereas in other embodiments the BSs 102 may communicate over unlicensed spectrums. The present disclosure is not intended to be limited to the implementation of any particular wireless communication system architecture or protocol. In another embodiment, the BSs 102 may communicate with the UEs 101 using the 3GPP 5G protocols.

If the wireless communication system 100 uses unlicensed spectrum, the UE may perform a channel access procedure (also named LBT, LBT Category 4) for AUL transmission, and obtain a COT. In LTE Rel-15 FeLAA, there are two ways for UE and eNB to share the COT. The first one is sharing an eNB-initiated COT with the UE for AUL transmission. The eNB may choose to permit or prohibit AUL transmission inside the eNB-initiated COT. This permission or prohibition of AUL transmissions within an eNB-initiated COT is indicated to the UE by one bit in C-PDCCH named “COT sharing indication for AUL.” If eNB indicates that COT sharing for AUL is allowed, then the UE performs Type 2 channel access (25 us one-shot LBT) before the start of AUL transmission, and transmits data within the UL subframes indicated by C-PDCCH. If eNB indicates that COT sharing for AUL is not allowed, then UE shall not transmit AUL within the UL subframes indicated by C-PDCCH.

The second way is sharing a UE-initiated COT with eNB for DL transmission. The UE may choose to permit or prohibit DL transmission inside the UE-initiated COT. This permission or prohibition of DL transmissions within a UE-initiated COT is indicated to eNB by one bit in AUL-UCI named “COT sharing indication.” This COT sharing indication indicates whether subframe n+X is allowed for DL transmission, wherein n is the subframe number where AUL-UCI is transmitted. X is an integer configured by the eNB as part of AUL RRC configuration, where 1<X<5. If UE transmits COT sharing indication in AUL-UCI in subframe n, then the UE will stop its AUL PUSCH transmission at symbol 12 in the subframe n+X−1 irrespective of the RRC configured location for the PUSCH ending symbol. Thus, the last symbol in subframe n+X−1 is blanked, so that the eNB can perform LBT for DL transmission in subframe n+X. It should be noted that for DL transmission in the UE-initiated COT, only PDCCH transmission spanning up to 2 symbols at the beginning of the subframe n+X is allowed. This PDCCH can contain Autonomous Uplink-Downlink Feedback Information (AUL-DFI) or UL grant to UE. In view of the above, the shared resource is limited and multiple UL-DL switching points are not allowed.

In NR uplink transmission, two schemes for configured grant transmission are supported: configured grant type 1, wherein an uplink grant is provided by RRC, including activation of the configured grant; and configured grant type 2, wherein the uplink transmission periodicity is provided by RRC and activation or deactivation as well as necessary information for transmission is provided by L1 control signaling similar to DL Semi-Persistent Scheduling (SPS).

The advantages of the two schemes are similar, which are: control signaling overhead is reduced, and to reduce the latency to some extent since no scheduling request-UL grant cycle is needed prior to data transmission. Configured grant type 1 sets all the transmission parameters using RRC signaling, including periodicity, time offset, and frequency resources as well as modulation and coding scheme (MCS). Configured grant type 2 is similar to LTE AUL transmission, i.e., RRC signaling is used to configure the time domain resource allocation, while the activation Downlink Control Information (DCI) provides necessary transmission parameters.

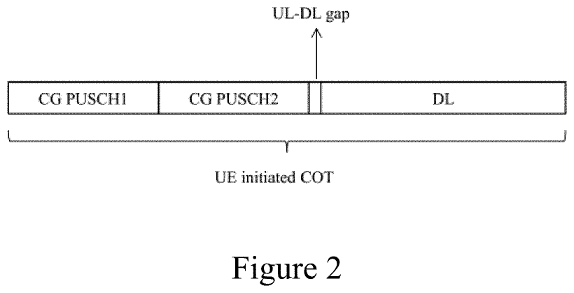

FIG. 2 illustrates a UE-initiated COT in NR network according to an embodiment of the subject application. Since the UE-initiated COT in NR network is much longer than that in LTE network, more resource can be shared with BS for DL transmission. When UE shares the UE-initiated COT to BS, UE needs to indicate to the BS the time domain resource reserved for DL transmission in the COT. Thus, more flexible timing and resource reservation need to be supported, such that the BS can fully use the shared DL resource.

The subject application focuses on sharing the UE-initiated COT with the BS, such that the BS can fully use the shared DL transmission resource. Thus, how to indicate the reserved DL resource, how to support multiple UL-DL-UL switching points, and how to support PDCCH transmission in the shared DL transmission would be further discussed.

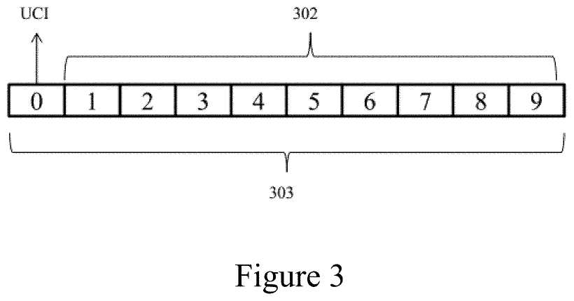

FIG. 3 illustrates a structure of the UE-initiated COT in NR network according to one embodiment of the subject application. In FIG. 3, if the absence of other technologies (e.g., WiFi) on the same carrier can be guaranteed, the UE initiated maximum COT (MCOT) 303 includes 10 slots, slot 0, slot 1, . . . , slot 9. For the configured grant uplink control information (CG-UCI) transmitted in slot 0, the maximum shared slots with the BS are slots 1-9, which can be used for the BS for DL transmission.

If the UE shares the COT to base station, the maximum number of slots which can be shared to the base station is determined as below. If the absence of other technologies (e.g., WiFi) on the same carrier cannot be guaranteed, the maximum COT is equal to 6 ms. Thus, the max number of slots included in the UE-initiated COT is 6 for 15 kHz subcarrier spacing; 12 for 30 kHz subcarrier spacing; 24 for 60 kHz subcarrier spacing; and 48 for 120 kHz subcarrier spacing. As a result, the max number of slots which can be shared to gNB is 5 for 15 kHz subcarrier spacing, 11 for 30 kHz subcarrier spacing, 23 for 60 kHz subcarrier spacing and 47 for 120 kHz subcarrier spacing. If the absence of other technologies (e.g., WiFi) on the same carrier can be guaranteed, the maximum COT is equal to 10 ms. Thus, the max number of slots included in the UE-initiated COT is 10 for 15 kHz subcarrier spacing; 20 for 30 kHz subcarrier spacing; 40 for 60 kHz subcarrier spacing; and 80 for 120 kHz subcarrier spacing. As a result, the max number of slots which can be shared to gNB is 9 for 15 kHz subcarrier spacing, 19 for 30 kHz subcarrier spacing, 39 for 60 kHz subcarrier spacing and 79 for 120 kHz subcarrier spacing.

In a preferred embodiment, a new field in UCI indicating that subsequent time resource within the COT is available for the BS for downlink transmission is introduced. FIG. 3 illustrates an allocation of the COT 303 in NR network determined by the new field according to one preferred embodiment of the subject application. The new field may indicate the starting slot index of one or more shared slots and the total number of consecutive shared slots. The starting slot index is indicated by a slot index with respect to the initial slot of the UE-initiated COT. For example, the initial slot in the UE-initiated COT may be indexed to slot 0, and the indexes of the subsequent slots are 1, 2, . . . , 9. There are

$$\frac{n ( n - 1 )}{2}$$

possibilities for the starting slot index and the number of consecutive shared slots within the UE-initiated COT, where n is the total number of slots in the UE-initiated COT.

Assuming there are no other technologies (for example, WiFi) on the same carrier and the subcarrier spacing is 15 kHz, thus the maximum number of slots in the UE-initiated COT is 10. For the configured grant (CG)-UCI transmitted in the slot 0, if the UE intends to share some slots with the BS, there are 9 possibilities; for UCI transmitted in slot 1, if the UE intends to share some slots with the BS, there are 8 possibilities; for UCI transmitted in slot 2, if the UE intends to share some slots with the BS, there are 7 possibilities, and so on. Thus, there are 45 possibilities in total when the maximum number of slots in the UE-initiated COT (i.e., n) is 10. Accordingly, the new field indicating the starting slot index and total number of consecutive shared slots requires

$$⌈ {log}_{2} \frac{n ( n - 1 )}{2} ⌉$$

bits to cover all the possibilities, where n is the total number of slots in the UE-initiated COT. If n=6, there are 15 possibilities, then 4 bits are needed in the UCI; if n=10, there are 45 possibilities, then 6 bits are need in the UCI.

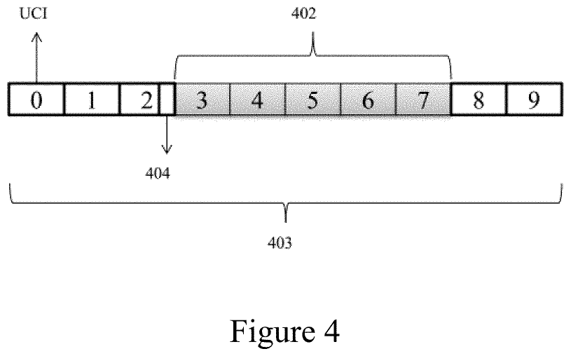

If only one UL-DL switching point is allowed, the UE shares all the remaining slots with the BS; if multiple UL-DL switching points are allowed, the UE can share some slots with the BS for DL transmission while keep the remaining slots for UL transmission. One example is shown in FIG. 4, where slot 3 to slot 7 are shared with the BS. That is, the starting slot is slot 3, and the number of consecutive shared slots is 5. In this case, slot 0, slot 1 and slot 2 are used for configured grant PUSCH transmission; slot 3 to slot 7 are used for DL transmission; and slot 8 and slot 9 are used for configured grant PUSCH or PUCCH transmission. That is, there are two UL-DL switching points in FIG. 4, one point is between slot 2 and slot 3, and the other is between slot 7 and slot 8.

A full slot includes 14 symbols, symbol 0, symbol 1, . . . , symbol 13. In this embodiment, only full slots are shared. That is, the 14 symbols of the first shared slot, e.g. slot 3 in FIG. 4, are shared with the BS for DL transmission. In other words, UE may receive DL transmission from symbol 0 in slot 3. In this case, the last one or two symbols in slot 2 are blanked as the LBT gap 404.

The duration of the LBT gap 404 should not be shorter than 25 us. The number of reserved symbols as the LBT gap depends on the subcarrier spacing. In case of 15 kHz subcarrier spacing, at least one symbol is blanked before the indicated DL transmission burs; in case of 30 kHz subcarrier spacing, at least one symbol is blanked before the indicated DL transmission burst; in case of 60 kHz subcarrier spacing, at least two symbols are blanked before the indicated DL transmission burst; in case of 120 kHz subcarrier spacing, at least four symbols are blanked before the indicated DL transmission burst.

A reserved value of the new filed may be used to indicate that there is no slot shared with the BS. By doing so, there is no need to include the one-bit UE-COT sharing indicator in the UCI.

This embodiment has several advantages: (1) there are less signaling overhead; (2) the algorithm is simple; and (3) single or multiple UL-DL switching points are allowed.

In one embodiment, the slot offset between the slot in which the UCI is transmitted and the first shared slot of the DL transmission is configured by RRC signaling. The maximum value of the slot level offset is dependent on the MCOT of the UE-initiated COT, and the number of consecutive shared slots is indicated in UCI. So, the first shared slot can only start from symbol 0 and leave the LBT gap before the first shared slot. In some cases, only full slots are shared for simplicity. Alternatively, the slot offset is indicated in UCI and the number of shared slots is configured by RRC signaling.

In some other embodiments, the UCI includes a new field which indicates the time domain resource sharing (TDRS) to the BS. When the UE intends to share the one or more slots with the BS, the TDRS field indicates one or more slots including partial slots are allocated to the BS in which the BS can perform DL transmission. When the UE does not intend to share the initiated COT with the BS, the TDRS field may indicate an invalid time domain resource allocation, a non-numerical value, a reserved value, or a predefined value. In this way, one-bit COT sharing indicator is not needed in UCI.

If the TDRS field indicates that one or more slots is shared with the BS for DL transmission, the first shared slot is slot n and the first shared slot begins from symbol 1, then the UE will stop the configured grant PUSCH transmission in the LBT gap before symbol/of slot n no matter what the RRC configured location for the PUSCH ending symbol is. The length of the LBT gap has been discussed in the above paragraphs and may be applied to this embodiment as well.

There are several embodiments for indicating TDRS to the BS. In one preferred embodiment, a plurality of time domain resource allocation patterns are configured by RRC signaling, and each of these patterns correspond to one or more consecutive slots. The UCI includes an indicator which dynamically indicates one of the patterns. Suppose the total number of the patterns is I, then the number of bits required for indicating these patterns is ┌log₂ I┐.

In this embodiment, RRC signaling is used to configure a new Information Element (IE) DL-TimeDomainResourceSharingList which is defined as follows:

```
DL-TimeDomainResourceSharingList::= SEQUENCE
{
  K3 INTEGER(0..Y) OPTIONAL
  startSymbolAndLength INTEGER (0..X)
  numberOfSharedSlots INTEGER(0..Maximum number of shared slots)
}
```

In the IE, the parameter K3 is the slot offset between the slot in which the UCI is transmitted and the first shared slot for the DL transmission. The maximum value of K3 is dependent on the MCOT of the UE-initiated COT.

The parameter startSymbolAndLength indicates a starting symbol index in the first shared slot for the DL transmission and a duration in a number of symbols in a last slot of the DL transmission. In other words, parameter startSymbolAndLength indicates both an index of the starting symbol in the first shared slot and an index of the ending symbol in the last shared slot. All slots and symbols between the starting symbol and the ending symbol are shared with the BS for DL transmission. X=127 in case the starting symbol can be any symbol within the first slot of the DL burst since 7 bits are needed. In case the starting symbol can only be started from symbol 0, then 4 bits are needed to simply indicate the number of symbols in the last slot of the DL burst or the symbol index of the last symbol of the last slot of the DL burst.

The parameter numberOfSharedSlots indicates the number of consecutive slots shared with the BS. The bit length of this field is dependent on the maximum slots which can be shared with the BS. To be more precise, max number of shared slots is dependent on the regulation allowed maximum COT and the adopted subcarrier spacing. If 4 slots can be shared in maximum, then 2 bits are needed in this field; and if 16 slots can be shared in maximum, then 4 bits are needed.

In another embodiment, a conventional IE, PDSCH-TimeDomainResourceAllocationList, can be used to indicate the one or more shared slots. A plurality of time domain resource allocation patterns are configured by RRC signaling, and each of these patterns correspond to one or more consecutive slots. The UCI includes an indicator which dynamically indicates one of the patterns. The conventional IE PDSCH-TimeDomainResourceAllocationList is defined as follows:

```
  PDSCH-TimeDomainResourceAllocationList ::= SEQUENCE
(SIZE(1..maxNrofDL-Allocations)) OF PDSCH-TimeDomainResourceAllocation
  PDSCH-TimeDomainResourceAllocation ::= SEQUENCE
  {
  K0 INTEGER(0..32) OPTIONAL
  mappingType ENUMERATED {typeA, typeB},
  startSymbolAndLength INTEGER (0..127)
  }
```

In the IE, the parameter K0 is reinterpreted to the slot offset between the slot in which UCI is transmitted and the first shared slot for the DL transmission. The field of startSymbolAndLength is reinterpreted to a combination of the index of the starting symbol of the first shared slot and the number of symbols in the last shared slot. The number of shared slots may be indicated in the UCI. Considering there may be multiple PUSCHs carrying multiple configured grant UCI in the multiple slots, the slot offset indicating the first shared slot is changed slot by slot.

In another embodiment, a conventional IE, PUSCH-TimeDomainResourceAllocationList, can be used to indicate the one or more shared slots. A plurality of time domain resource allocation patterns are configured by RRC signaling, and each of these patterns correspond to one or more consecutive slots. The UCI includes an indicator which dynamically indicates one of the patterns. The conventional IE PUSCH-TimeDomainResourceAllocationList is defined as follows:

```
  PUSCH-TimeDomainResourceAllocationList ::= SEQUENCE
(SIZE(1..maxNrofUL-Allocations)) OF PUSCH-TimeDomainResourceAllocation
  PUSCH-TimeDomainResourceAllocation ::= SEQUENCE
  {
  K2 INTEGER(0..32) OPTIONAL
  mappingType ENUMERATED {typeA, typeB},
  startSymbolAndLength INTEGER (0..127)
  }
```

In the IE, the parameter K2 is reinterpreted to the slot offset between the slot in which the UCI is transmitted and the first shared slot for the DL transmission. The field of startSymbolAndLength is reinterpreted to a combination of the index of the starting symbol of the first shared slot and the number of symbols in the last shared slot. The number of shared slots is indicated in the UCI. Considering there may be multiple PUSCHs carrying multiple configured grant UCI in the multiple slots, the slot offset indicating the first shared slot is changed slot by slot.

In some other embodiments, the UCI includes an indicator which indicates an index of a time domain resource allocation table. Each row in the table includes the following parameters: the slot offset between the slot in which the UCI is transmitted and the first shared slot for the DL transmission, the start symbol and length indicator, and the number of shared slots. The maximum value of the slot offset is dependent on the MCOT of the UE-initiated COT. Suppose the total number of rows in the time domain resource allocation table is I, then the number of bits required for indicating the TDRS in the UCI is ┌log₂ I┐. The time domain resource allocation table may be preconfigured (e.g., predefined in standard).

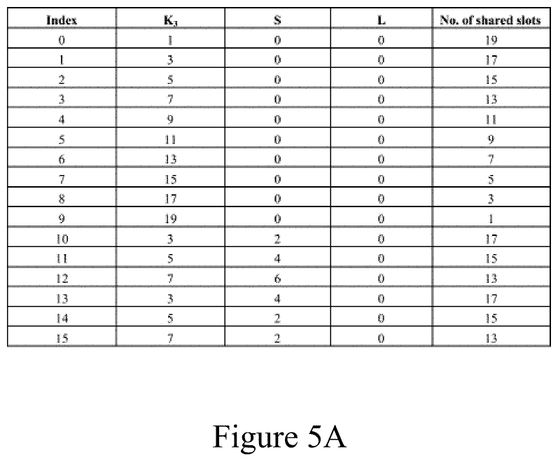

FIG. 5A illustrates an embodiment of a DL time domain resource allocation table for normal CP. In FIG. 5A, the maximum number of slots in one UE-initiated COT is assumed to be 20, thus the maximum number of shared slots is 19. Furthermore, single UL-to-DL switching point is assumed in FIG. 5A, which implies the UE can't transmit any UL signals or channels in its COT after it shares the COT with the BS. So the value of K₃ plus the number of shared slots in each row in the table of FIG. 5A is equal to 20.

In another embodiment, the first shared slot can only start from symbol 0, and the LBT gap may be before the first shared slot. FIG. 5B illustrates another embodiment of a DL time domain resource allocation table for normal CP. In FIG. 5B, the maximum number of slots in one UE-initiated COT is assumed to be 20. Therefore, the maximum number of shared slots is 19. Furthermore, multiple UL-to-DL switching point is allowed in FIG. 5B, which implies the UE can transmit any HARQ-ACK in its COT for the PDSCHs transmitted in same COT after it shares the COT with the BS. Thus, the value of K₃ plus the number of shared slots in each row in the table of FIG. 5B is not larger than 20, and the rest slots or symbols may be used to transmit the HARQ-ACK mentioned above.

In some other embodiments, the slot level offset between the slot where CG-UCI is transmitted and the first slot of the DL burst which is to be shared is configured by RRC signaling. The maximum value of K3 is dependent on the MCOT of the UE-initiated COT. Meanwhile, the number of shared slots is indicated in CG-UCI. So the first shared slot can only start from symbol 0 to leave the LBT gap before the first shared slot. Only full slots are shared for simplicity.

In some other embodiments, the UCI includes an indicator which indicates a SFC indicating a plurality of consecutive slots shared with the BS for DL transmission. Upon receipt of an indicator in the UCI indicating a SFC, the BS knows which slots or symbols are allocated to the BS. If the UCI only indicates slots or symbols for UL transmission, the BS knows that there is no shared slot.

A list including the slot format combinations is configured by RRC signaling. The new field for SFC indication is included in UCI.

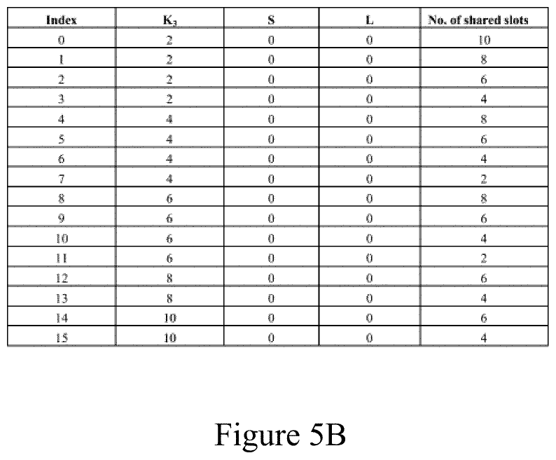

FIG. 6 shows an allocation of COT determined by a SFC according to one embodiment of the subject application. In FIG. 6, in the UE-initiated COT 603, the UCI is transmitted in the slot 0, followed by the slot 1 and slot 2, which are UL slots 605, then followed by the shared slots 602 for the DL transmission. The LBT gap 604 is at the end of slot 2.

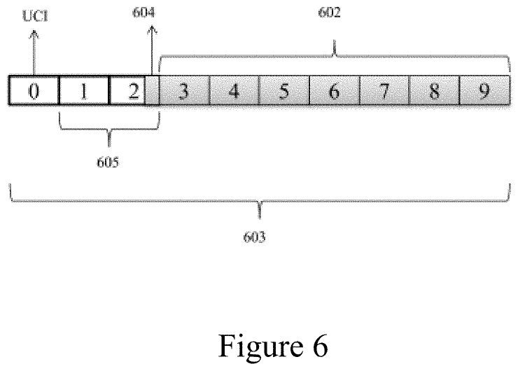

FIG. 7 shows an allocation of COT determined by a SFC according to another embodiment of the subject application. In FIG. 7, in the UE-initiated COT 703, the UCI is transmitted in the slot 0, followed by the slot 1 and slot 2, which are the UL slots 705, then followed by the shared slots 702 for the DL transmission, the shared slots 702 follows the LBT gap 704, which is at the end of slot 2. In FIG. 7, the UE keeps a portion of slot 8, and slot 9 to perform UL transmission following the LBT gap 706.

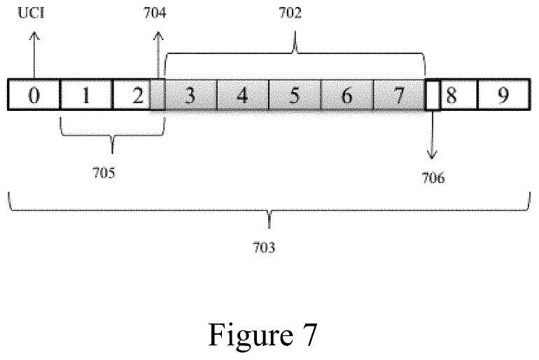

FIG. 8 shows an allocation of COT determined by a SFC according to yet another embodiment of the subject application. In FIG. 8, in the UE-initiated COT 803, the UCI is transmitted in the slot 0, followed by the slot 1, slot 2, which are full slots for UL transmission, and marked with the reference numeral 805, and followed by a number of UL symbols 806 in slot 3. The shared slots 802 for the DL transmission follows the LBT gap 807, which include full slots 808 (i.e., slot 4, slot 5 and slot 6) and a number of symbols 809 in slot 7. The UE keeps slot 8, and slot 9 to perform UL transmission after the LBT gap 804.

With the SFC indication in CG-UCI, the BS can clearly know the shared resource, while multiple UL-DL-UL switching points are available.

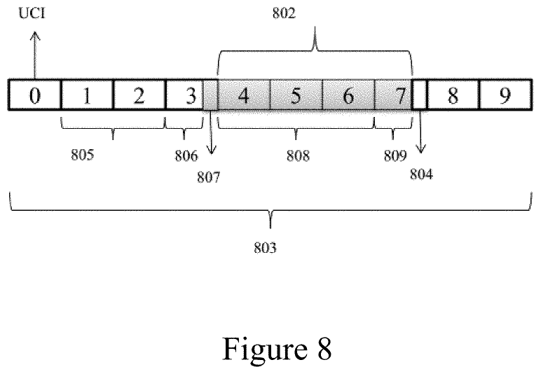

FIG. 9 illustrates a method performed by a UE for wireless communication according to a preferred embodiment of the subject disclosure. In step 901, a UE (e.g., UE 101 as shown in FIG. 1) receives, from a BS (e.g., BS 102 as shown in FIG. 1), a signaling configuring resource for transmitting uplink data. In step 902, the UE performs a channel access procedure for transmitting the uplink data on the configured resource and obtains a COT. In step 903, the UE transmits to the BS, the uplink data on the configured resource within the COT. In step 904, the UE transmits to the BS, uplink control information (UCI) associated with the uplink data indicating that subsequent time resource within the COT is available for the BS for downlink transmission.

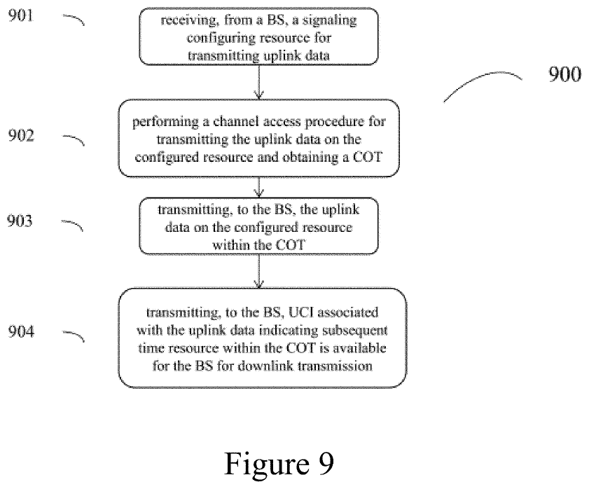

FIG. 10 illustrates a method performed by a BS for wireless communications according to a preferred embodiment of the subject disclosure. In step 1001, a BS (e.g., BS 102 as shown in FIG. 1) transmits, to a UE (e.g., UE 101 as shown in FIG. 1), a signal configuring resource for transmitting uplink data. In step 1002, the BS receives, from the UE, the uplink data on the configured resource within a COT, the COT is initiated by the UE after preforming a channel access procedure. In step 1003, the BS receives, from the UE, UCI associated with the uplink data indicating that subsequent time resource within the COT is available for the BS for downlink transmission. In step 1004, the BS transmits downlink transmission in the subsequent time resource.

The subsequent time resource may include a plurality of consecutive slots in the COT. In some embodiments, the subsequent time resource may include a plurality of consecutive slots and symbols in the COT.

In order to indicate the plurality of consecutive slots, the subject application introduces an indicator included in the UCI. The indicator indicates the first shared slot and the length of the plurality of consecutive slots. For example, in FIG. 3, the indicator indicates that the first slot may be slot 3, and the length of the plurality of consecutive slots is 6. Then the BS would know that slot 3 to slot 6 could be used for DL transmission.

The index of the first slot of the plurality of consecutive slots is defined relative to a first slot of the COT. For example, in FIG. 3, the first slot of the COT is slot 0, and the first slot of the plurality of consecutive slots in FIG. 3 may be slot 1.

In one embodiment, the first slot of the plurality of consecutive slots starts from symbol 0, and each slot of the plurality of consecutive slots is a full slot.

Suppose the total number of slots within the COT is n, then the maximum combinations of the slots that could be allocated to the BS is

$$\frac{n ( n - 1 )}{2} ,$$

then the indicator in UCI at least includes

$$⌈ {log}_{2} \frac{n ( n - 1 )}{2} ⌉$$

bits to indicates all of the combinations. One value of the indicator may be used to indicate that there is no slots shared with the BS, in other words, the number of the plurality of consecutive slots is zero.

In unlicensed spectrum, the BS performs a channel access procedure, for example, before transmission in the UE-initiated COT. Thus, at least one symbol at the end of the slot preceding a first slot of the plurality of consecutive slots is blanked.

In a preferred embodiment, the RRC signaling configures a slot offset between the slot in which the UCI is transmitted and a first slot of the plurality of consecutive slots, and the UCI includes an indicator indicating a number of the plurality of consecutive slots. In another preferred embodiment, the RRC signaling configures the number of the plurality of consecutive slots, and the UCI includes an indicator indicating a slot offset between a slot in which the UCI is transmitted and a first slot of the plurality of consecutive slots.

In another preferred embodiment, the RRC signaling configures a plurality of time domain resource allocation patterns, and the indicator included in the UCI indicates one of the patterns to the BS. Each pattern in the plurality of time domain resource allocation patterns indicates the slot offset and the number of plurality of consecutive slots. The pattern may further indicate a starting symbol in the first slot and an ending symbol in an ending slot of the plurality of consecutive slots.

In a preferred embodiment, the RRC signaling defines a plurality of time domain resource allocation patterns for PDSCH time domain resource allocation. The RRC signaling also defines a plurality of time domain resource allocation patterns for PUSCH time domain resource allocation

In another preferred embodiment, the plurality of time domain resource allocation patterns is preconfigured in a table, and each row in the table includes one pattern. For example, each row in the table in FIG. 5A and FIG. 5B is a time domain resource allocation pattern, which corresponds to a plurality of consecutive slots. The UCI includes an indicator indicating one index of the table. For instance, if the value of the indicator is 2, according to the table in FIG. 5A, the value of K3 is 5, the value of S is 0, the value of L is 0, and the value of the number of shared slots is 15.

In another preferred embodiment, the UCI may include an indicator which indicates a SFC, which corresponds to a plurality of consecutive slots. The SFC is configured by RRC singling, and includes a number of slots for UL transmission and a number of slots for DL transmission. For example, the SFC structure in FIG. 6 includes slot 1 and slot 2 for UL transmission, and slots 3-9 for DL transmission. The SFC further includes one or more slots for UL transmission following the number of slots for DL transmission as shown in FIG. 7.

In another preferred embodiment, the SFC is configured by RRC singling, and includes a number of slots for UL transmission, a number of symbols for UL transmission, a number of slots for DL transmission, and a number of symbols for DL transmission, arranged in sequence. For example, as shown in FIG. 8, the SFC includes slots 805 for UL transmission, symbols 806 for UL transmission, slots 807 for DL transmission, and symbols 808 for DL transmission, arranged in sequence.

In another preferred embodiment, the subsequent time resource may include a plurality of consecutive symbols in one slot. The UCI includes an indicator which indicates a slot offset between a slot in which the UCI is transmitted and the slot where the plurality of consecutive symbols are located. The UCI may further include an indicator indicating an index of the slot. The index of the slot is defined relative to a first slot of the COT. Alternatively, the UCI includes an indicator indicating a number of the plurality of consecutive symbols.

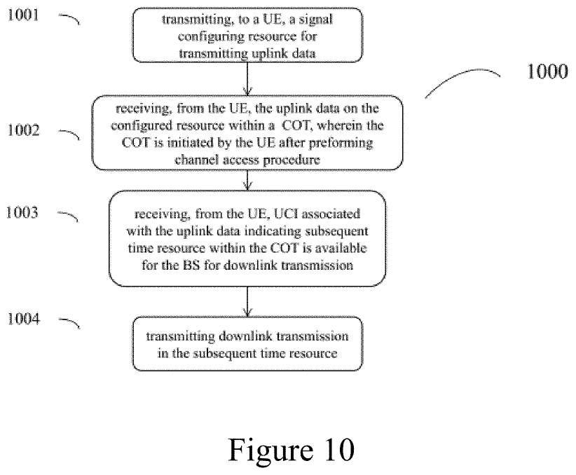

FIG. 11 illustrates a block diagram of a UE according to the embodiments of the present disclosure. The UE 101 may include a receiving circuitry, a processor, and a transmitting circuitry. In one embodiment, the UE 101 may include a non-transitory computer-readable medium having stored thereon computer-executable instructions; a receiving circuitry; a transmitting circuitry; and a processor coupled to the non-transitory computer-readable medium, the receiving circuitry and the transmitting circuitry. The computer executable instructions can be programmed to implement a method (e.g. the method in FIG. 9) with the receiving circuitry, the transmitting circuitry and the processor. That is, upon performing the computer executable instructions, the receiving circuitry may receive, from a base station (BS), a signaling configuring resource for transmitting uplink data, the processor may perform a channel access procedure for transmitting the uplink data on the configured resource and obtaining a COT, and the transmitting circuitry may transmit, to the BS, the uplink data on the configured resource within the COT and transmit, to the BS, UCI associated with the uplink data indicating subsequent time resource within the COT is available for the BS for downlink transmission.

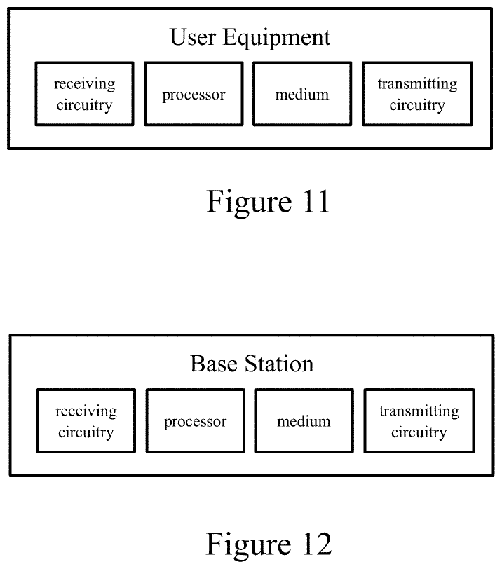

FIG. 12 depicts a block diagram of a BS according to the embodiments of the present disclosure. The BS 102 may include a receiving circuitry, a processor, and a transmitting circuitry. In one embodiment, the BS may include a non-transitory computer-readable medium having stored thereon computer-executable instructions; a receiving circuitry; a transmitting circuitry; and a processor coupled to the non-transitory computer-readable medium, the receiving circuitry and the transmitting circuitry. The computer executable instructions can be programmed to implement a method (e.g. the method in FIG. 10) with the receiving circuitry, the transmitting circuitry and the processor. That is, upon performing the computer executable instructions, the transmitting circuitry may transmit, to a UE, a signal configuring resource for transmitting uplink data, the receiving circuitry may receive, from the UE, the uplink data on the configured resource within a COT, wherein the COT is initiated by the UE after preforming a channel access procedure, and receive, from the UE, UCI associated with the uplink data indicating subsequent time resource within the COT is available for the BS for downlink transmission, and then the transmitting circuitry may transmit downlink transmission in the subsequent time resource.

The method of the present disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method performed by a user equipment for wireless communication, comprising:
receiving, from a base station, a signaling configuring resource for transmitting uplink data;
performing a channel access procedure for transmitting the uplink data on the configured resource and obtaining a channel occupancy time;
transmitting, to the base station, the uplink data on the configured resource within the channel occupancy time; and
transmitting, to the base station, uplink control information associated with the uplink data indicating a subsequent time resource within the channel occupancy time is available for the base station for downlink transmission, the subsequent time resource comprising a plurality of consecutive slots.

2. (canceled)

3. The method of claim 1, wherein the uplink control information includes an indicator indicating the plurality of consecutive slots, and the indicator indicates an index of a first slot of the plurality of consecutive slots and a number of the plurality of consecutive slots.

4. The method of claim 3, wherein the index of the first slot of the plurality of consecutive slots is defined relative to a first slot of the channel occupancy time.

5-7. (canceled)

8. The method of claim 3, wherein a value of the indicator indicates that the number of the plurality of consecutive slots is zero.

9. The method of claim 1, wherein at least one symbol at the end of the slot preceding a first slot of the plurality of consecutive slots is blanked.

10. The method of claim 1, wherein a slot offset between a slot in which the uplink control information is transmitted and a first slot of the plurality of consecutive slots is configured by radio resource control signaling, and the uplink control information includes an indicator indicating a number of the plurality of consecutive slots.

11. The method of claim 1, wherein a number of the plurality of consecutive slots is configured by radio resource control signaling, and the uplink control information includes an indicator indicating a slot offset between a slot in which the uplink control information is transmitted and a first slot of the plurality of consecutive slots.

12. The method of claim 1, wherein a plurality of time domain resource allocation patterns are configured by radio resource control signaling and the uplink control information includes an indicator indicating one of the plurality of time domain resource allocation patterns corresponding to the plurality of consecutive slots.

13. The method of claim 12, wherein each of the plurality of time domain resource allocation patterns indicates a slot offset between a slot in which the uplink control information is transmitted and a first slot of the plurality of consecutive slots, and indicates a number of the plurality of consecutive slots.

14-16. (canceled)

17. The method of claim 1, wherein a table of time domain resource allocation patterns is preconfigured and the uplink control information includes an indicator indicating an index of the table corresponding to the plurality of consecutive slots.

18-52. (canceled)

53. An apparatus, comprising:
a receiving circuitry to receive, from a base station, a signaling configuring resource for transmitting uplink data;
a processor to execute computer-executable instructions configured to cause the apparatus to perform a channel access procedure for transmitting the uplink data on the configured resource and obtaining a channel occupancy time; and
a transmitting circuitry to transmit, to the base station, the uplink data on the configured resource within the channel occupancy time, and uplink control information associated with the uplink data indicating a subsequent time resource within the channel occupancy time is available for the base station for downlink transmission, the subsequent time resource comprising a plurality of consecutive slots.

54. An apparatus, comprising:
a receiving circuitry;
a transmitting circuitry; and
a processor coupled to the receiving circuitry and the transmitting circuitry configured to cause the apparatus to:
transmit, to a user equipment, a signal configuring resource for transmitting uplink data;
receive, from the user equipment, the uplink data on the configured resource within a channel occupancy time initiated by the user equipment after preforming a channel access procedure;
receive, from the user equipment, uplink control information associated with the uplink data indicating a subsequent time resource within the channel occupancy time is available for downlink transmission, the subsequent time resource comprising a plurality of consecutive slots; and
transmit the downlink transmission in the subsequent time resource.

55. The apparatus of claim 53, wherein uplink control information includes an indicator indicating the plurality of consecutive slots, and the indicator indicates an index of a first slot of the plurality of consecutive slots and a number of the plurality of consecutive slots.

56. The apparatus of claim 55, wherein a value of the indicator indicates that the number of the plurality of consecutive slots is zero.

57. The apparatus of claim 53, wherein at least one symbol at the end of the slot preceding a first slot of the plurality of consecutive slots is blanked.

58. The apparatus of claim 53, wherein a slot offset between a slot in which the uplink control information is transmitted and a first slot of the plurality of consecutive slots is configured by radio resource control signaling, and the uplink control information includes an indicator indicating a number of the plurality of consecutive slots.

59. The apparatus of claim 53, wherein a number of the plurality of consecutive slots is configured by radio resource control signaling, and the uplink control information includes an indicator indicating a slot offset between a slot in which the uplink control information is transmitted and a first slot of the plurality of consecutive slots.

60. The apparatus of claim 59, wherein a plurality of time domain resource allocation patterns are configured by radio resource control signaling and the uplink control information includes an indicator indicating one of the plurality of time domain resource allocation patterns corresponding to the plurality of consecutive slots.

61. The apparatus of claim 60, wherein each of the plurality of time domain resource allocation patterns indicates a slot offset between a slot in which the uplink control information is transmitted and a first slot of the plurality of consecutive slots, and indicates a number of the plurality of consecutive slots.

62. The apparatus of claim 53, wherein a table of time domain resource allocation patterns is preconfigured and the uplink control information includes an indicator indicating an index of the table corresponding to the plurality of consecutive slots.
